(19) United States
(12) Patent Application Publication
(10) Pub. No.: US 2017/0176933 A1
(43) Pub. Date: Jun. 22, 2017

(54) HOLOGRAPHIC DISPLAY APPARATUS AND METHOD USING DIRECTIONAL BACKLIGHT UNIT (BLU)

(71) Applicant: ELECTRONICS AND TELECOMMUNICATIONS RESEARCH INSTITUTE, DAEJEON (KR)

(72) Inventors: Hyun Eui KIM, Cheongju (KR); Tae One KIM, Daejeon (KR)

(21) Appl. No.: 15/381,962

(22) Filed: Dec. 16, 2016

(30) Foreign Application Priority Data
Dec. 18, 2015 (KR) 10-2015-0182032
May 3, 2016 (KR) 10-2016-0054844

(51) Int. Cl. G03H 1/22; G02F 1/1335; G02B 26/08

(52) U.S. Cl. CPC G03H 1/2286; G03H 1/2294; G02B 26/0833; G02F 1/133526; G02F 1/133553; G02B 26/0808; G02F 1/133504; G03H 2223/19; G03H 2223/23; G03H 2223/24; G03H 2222/35

(57) ABSTRACT

A holographic display apparatus and method using a directional backlight unit (BLU) are provided. The holographic display apparatus may include a BLU configured to control light to be incident on a spatial light modulator (SLM) using a plurality of mirrors, and the SLM configured to modulate the incident light based on image information and to display a holographic image.

### CROSS-REFERENCE TO RELATED APPLICATION(S)

This application claims the priority benefit of Korean Patent Application No. 10-2015-0182032 filed on Dec. 18, 2015, and Korean Patent Application No. 10-2016-0054844 filed on May 3, 2016, in the Korean Intellectual Property Office, the disclosures of which are incorporated herein by reference for all purposes.

### BACKGROUND

1. Field of the Invention

One or more example embodiments relate to a holographic display apparatus and method using a directional backlight unit (BLU).

2. Description of the Related Art

A holographic display technology may be used to display a holographic image to a user. In the holographic display technology, to increase a viewing angle at which a user views a holographic image, a gap between pixels in a spatial light modulator (SLM) may need to be reduced to be less than or equal to a micron.

However, because it is impossible to reduce the gap between the pixels as described above using current display technologies, a method of increasing a viewing angle using a space-division multiplexing or time-division multiplexing has been developed.

A time-division multiplexing scheme according to a related art is used to steer incident light to quickly pass through a field of vision of a user using a light steering device, for example, a galvanometer or a rotating hexagonal mirror, and to increase a viewing angle.

However, because the light steering device uses a motor to steer the incident light, noise and vibrations may occur due to an operation of the motor.

Also, a rotational speed of the motor is used to determine a viewing angle expansion range and a frame rate of a display, and thus the rotational speed of the motor may need to increase to increase the frame rate and the viewing angle expansion range. However, actually, it is difficult to increase the frame rate and the viewing angle expansion range due to a physical limitation of the rotational speed of the motor.

Thus, there is a desire for an apparatus and method for increasing a viewing angle expansion range and a frame rate of a display without noise and vibrations.

### SUMMARY

Example embodiments may provide an apparatus and method for using a digital micromirror device (DMD) as a light steering device of a backlight unit (BLU) in a holographic display apparatus, to prevent an occurrence of noise and vibrations for steering of incident light and to reduce a power consumption for the light steering device.

According to an aspect, there is provided a holographic display apparatus including a backlight unit (BLU) configured to control light to be incident on a spatial light modulator (SLM) using a plurality of mirrors, and the SLM configured to modulate the incident light based on image information and to display a holographic image.

The BLU may include a digital micromirror device (DMD) including a plurality of mirrors configured to diffract the incident light in a range between orders based on a grating equation, a first lens configured to concentrate the diffracted light onto a preset position of a focal point, a liquid crystal optical shutter configured to open a region corresponding to the diffracted light based on positions of the orders and a direction of the diffracted light, and a second lens configured to allow light passing through the liquid crystal optical shutter to be incident on the SLM.

The DMD may be configured to change a diffraction direction in which the incident light is diffracted, by controlling a tilt of each of the mirrors, to direct beams of the BLU.

The DMD may be configured to set a maximum angle of diffraction of each of the mirrors based on a gap between the mirrors, an input wavelength of the incident light and an order mode.

The liquid crystal optical shutter may be further configured to open a region that is based on a movement pattern of the diffracted light so that an order passes through the liquid crystal optical shutter when the direction of the diffracted light corresponds to a position of the order.

The liquid crystal optical shutter may be further configured to open a region adjacent to an order in an X-axis direction when phase shift encoding of the incident light is performed to move the diffracted light in the X-axis direction.

The liquid crystal optical shutter may be further configured to open a region adjacent to an order in a Y-axis direction when phase shift encoding of the incident light is performed to move the diffracted light in the Y-axis direction.

The liquid crystal optical shutter may be further configured to open a region diagonally adjacent to an order when phase shift encoding of the incident light is performed to move the diffracted light in an X-axis direction and a Y-axis direction.

The liquid crystal optical shutter may be further configured to open a region that is not adjacent to an order when the direction of the diffracted light is out of the range.

The liquid crystal optical shutter may be further configured to control an intensity of the light that is diffracted by the DMD and that passes through the liquid crystal optical shutter using a liquid crystal included in the liquid crystal optical shutter.

A focal length of the first lens may be less than a focal length of the second lens, and a beam width of light incident on the SLM may be determined based on the focal length of the first lens and the focal length of the second lens.

The incident light may have a planar wavefront and a spatially uniform intensity, and may be incident at a blaze angle on the DMD.

According to another aspect, there is provided a holographic display method including controlling, by a BLU, light to be incident on an SLM using a plurality of mirrors, and modulating, by the SLM, the incident light based on image information and displaying a holographic image.

The BLU may include a DMD including a plurality of mirrors configured to diffract the incident light in a range between orders based on a grating equation, a first lens configured to concentrate the diffracted light onto a preset position of a focal point, a liquid crystal optical shutter configured to open a region corresponding to the diffracted light based on positions of the orders and a direction of the diffracted light, and a second lens configured to allow light passing through the liquid crystal optical shutter to be incident on the SLM.

The controlling may include opening, by the liquid crystal optical shutter, a region that is based on a movement pattern of the diffracted light so that an order passes through the liquid crystal optical shutter when the direction of the diffracted light corresponds to a position of the order.

The controlling may include opening, by the liquid crystal optical shutter, a region adjacent to an order in an X-axis direction when phase shift encoding of the incident light is performed to move the diffracted light in the X-axis direction.

The controlling may include opening, by the liquid crystal optical shutter, a region adjacent to an order in a Y-axis direction when phase shift encoding of the incident light is performed to move the diffracted light in the Y-axis direction.

The controlling may include opening, by the liquid crystal optical shutter, a region diagonally adjacent to an order when phase shift encoding of the incident light is performed to move the diffracted light in an X-axis direction and a Y-axis direction.

The controlling may include opening, by the liquid crystal optical shutter, a region that is not adjacent to an order when the direction of the diffracted light is out of the range.

The controlling may include controlling, by the liquid crystal optical shutter, an intensity of the light that is diffracted by the DMD and that passes through the liquid crystal optical shutter using a liquid crystal included in the liquid crystal optical shutter.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a holographic display apparatus according to an example embodiment;

FIG. 2 is a diagram illustrating an example of a backlight unit (BLU) of the holographic display apparatus of FIG. 1;

FIG. 3 is a diagram illustrating an example in which light incident on a digital micromirror device (DMD) is in a blaze condition according to an example embodiment;

FIG. 4 is a diagram illustrating an example of a process of inducing a blaze condition in a DMD according to an example embodiment;

FIG. 5 is a diagram illustrating an example of an operation of a liquid crystal optical shutter according to an example embodiment; and

FIG. 6 is a flowchart illustrating a holographic display method according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

According to example embodiments, a holographic display method may be performed by a holographic display apparatus.

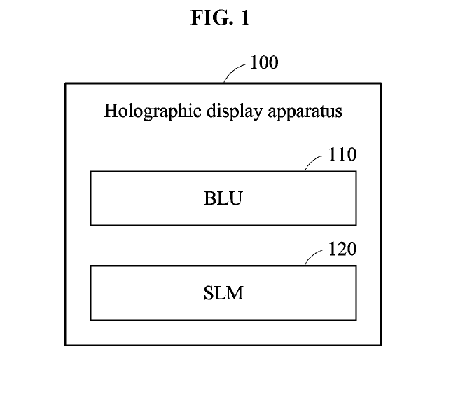

FIG. 1 is a block diagram illustrating a holographic display apparatus 100 according to an example embodiment.

Referring to FIG. 1, the holographic display apparatus 100 may include a backlight unit (BLU) 110 and a spatial light modulator (SLM) 120.

The BLU 110 may control light to be incident on the SLM 120 using a plurality of mirrors. The incident light may have a planar wavefront and a spatially uniform intensity and may be incident at a blaze angle on a digital micromirror device (DMD).

The BLU 110 may include the DMD, a first lens, a liquid crystal optical shutter, and a second lens. The DMD may include a plurality of mirrors configured to diffract the incident light in a range between orders based on a grating equation. The first lens may concentrate the diffracted light onto a preset position of a focal point. The liquid crystal optical shutter may open a specific region corresponding to the diffracted light based on positions of the orders and a direction of the diffracted light. The second lens may allow light passing through the liquid crystal optical shutter to be incident on the SLM 120.

The DMD may change a diffraction direction in which the incident light is diffracted, by controlling a tilt of each of the mirrors included in the DMD, and may control switching of pixels of the BLU 110. Also, the DMD may set a maximum angle of diffraction of each of the mirrors based on a gap between the mirrors, an input wavelength of the incident light and an order mode.

When the direction of the diffracted light corresponds to a position of an order, the liquid crystal optical shutter may open a region that is based on a movement pattern of the diffracted light so that the order may pass through the liquid crystal optical shutter.

In an example, when phase shift encoding of the incident light is performed to move the diffracted light in an X-axis direction, the liquid crystal optical shutter may open a region adjacent to an order in the X-axis direction. In another example, when phase shift encoding of the incident light is performed to move the diffracted light in a Y-axis direction, the liquid crystal optical shutter may open a region adjacent to an order in the Y-axis direction.

In still another example, when phase shift encoding of the incident light is performed to move the diffracted light in the X-axis direction and the Y-axis direction, the liquid crystal optical shutter may open a region diagonally adjacent to an order. In yet another example, when the direction of the diffracted light is out of the range, the liquid crystal optical shutter may open a region that is not adjacent to an order.

The liquid crystal optical shutter may control an intensity of the light that is diffracted by the DMD and that passes through the liquid crystal optical shutter using a liquid crystal included in the liquid crystal optical shutter.

A focal length of the first lens may be less than a focal length of the second lens. The first lens may be used to determine a beam width of light incident on an SLM based on the focal length of the first lens and the focal length of the second lens.

The SLM 120 may modulate the incident light based on image information and may display a holographic image.

The holographic display apparatus 100 may use the DMD including the plurality of mirrors as a light steering device of the BLU 110, and thus it is possible to prevent noise and vibrations from occurring and to reduce a power consumption for the light steering device, unlike a holographic display apparatus including a light steering device, for example, a gimbal scanner, a galvano scanner or a risley scanner, using a motor according to a related art.

Also, in a holographic display apparatus with a time-division multiplexing structure, a frame rate of a reproduced holographic image and a viewing angle of a display may be limited based on a steering speed of incident light. Thus, the holographic display apparatus including the light steering device using the motor according to the related art may attempt to increase the steering speed by rotating the motor at a relatively high speed, however, a rotational speed of the motor actually has a physical limitation. On the other hands, the holographic display apparatus 100 may control an angle of diffraction by a tilt of each of the mirrors included in the DMD, and thus a light steering speed may be higher than that of the light steering device using the motor according to the related art. For example, each of the mirrors in the DMD may have a switching rate of tens of thousands of Hertz (Hz), and the steering speed may be the same as a switching rate of each of the mirrors in the DMD.

Thus, when the holographic display apparatus 100 is used as a holographic display apparatus with a time-division multiplexing structure, a viewing angle of a display may be expanded and a frame rate of a reproduced holographic image may increase.

Also, the light steering device using the motor according to the related art may have a reflection structure and a refraction structure. In the reflection structure, an angle of reflection may be determined based on a steering direction, and accordingly a width and phase of a beam to be output may be differently distorted. In the refraction structure, an optical aberration may occur due to an optical characteristic, for example, a curvature and a material of an optical component, and accordingly a phase of a steered beam may be distorted. Thus, the light steering device using the motor according to the related art may not be suitable to be used as a BLU of a holographic display apparatus.

However, the holographic display apparatus 100 may control an angle of diffraction by switching the mirrors included in the DMD, to control a phase of diffracted light, and thus it is possible to prevent a distortion of incident light.

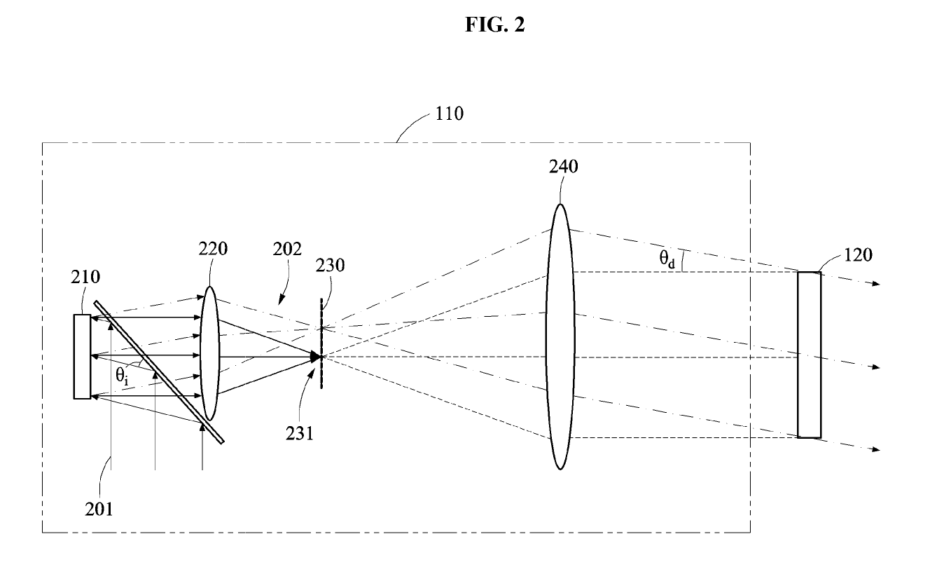

FIG. 2 is a diagram illustrating an example of the BLU 110 of FIG. 1.

Referring to FIG. 2, the BLU 110 may include a DMD 210, a first lens 220, a liquid crystal optical shutter 230 and a second lens 240.

The DMD 210 may include a plurality of mirrors to diffract incident light in a range between orders based on a grating equation.

The DMD 210 may be, for example, a diffraction type display apparatus with a micro-sized mirror installed on a semiconductor. Each of the mirrors included in the DMD 210 may be switched while tilting ±12 degrees about a diagonal axis. For example, the BLU 110 may change a diffraction direction in which incident light is diffracted, by controlling a tilt of each of the mirrors in the DMD 210, and may control a direction of light to be output.

To change the diffraction direction, a grating structure may be changed based on a grating pattern image reproduced on the DMD 210, and the incident light may be steered at an arbitrary angle and may be transferred to the SLM 120.

An angle of diffraction that is a range of tilts controlled in the DMD 210 may be limited by a gap between the mirrors in the DMD 210. The gap between the mirrors may be the same as a gap between pixels. For example, when a gap between pixels is denoted by p, an order mode is denoted by m and an input wavelength is denoted by λ, a maximum angle of diffraction of the DMD 210 may be defined as “θ=sin−1(mλ/p)” by a grating equation. When incident light is diffracted, an order may be generated based on a grating structure of the DMD 210 as shown in FIG. 2. The order mode may be a number for indicating a spatial position of each of orders.

The diffracted light controlled by the DMD 210 may be steered in the range between orders based on the grating equation. When the gap between the pixels is greater than or equal to a threshold or when a wavelength of input light is less than or equal to a threshold wavelength, a range for steering the diffracted light may decrease. In this example, the DMD 210 may operate based on a phase shifting scheme using off-axis encoding.

For example, the DMD 210 may have a reflective grating structure. In this example, light may be incident on the DMD 210 at a blaze angle. The incident light may be coherent light collimated to correspond to a pixel structure of the DMD 210.

Because the incident light is incident on the DMD 210 at the blaze angle, light concentrated on a 0^{th} order may be concentrated onto a target order based on a blaze condition. Thus, it is possible to achieve a maximum diffraction efficiency, and to avoid light beams that are concentrated on the 0^{th} order and are not diffracted.

The first lens 220 may concentrate the diffracted light onto a preset position of a focal point. The liquid crystal optical shutter 230 may be located in a rear portion of the focal point, for example, on a Fourier plane, of the first lens 220. A distance between the DMD 210 and the first lens 220 may correspond to a front focal length of the first lens 220.

The liquid crystal optical shutter 230 may open a specific region corresponding to the diffracted light based on positions of the orders and a direction of the diffracted light. For example, when the light diffracted and steered by the DMD 210 passes the orders, the liquid crystal optical shutter 230 may open a corresponding region between the orders.

Also, the liquid crystal optical shutter 230 may control an intensity of the diffracted light using a liquid crystal, which may lead to a constant intensity ratio of incident light.

The second lens 240 may allow light passing through the liquid crystal optical shutter 230 to be incident on the SLM 120. A distance between the second lens 240 and the liquid crystal optical shutter 230 may correspond to a front focal length of the second lens 240. A distance between the second lens 240 and the SLM 120 may correspond to a rear focal length of the second lens 240.

The first lens 220 and the second lens 240 may form a 4f system. Also, a focal length of the first lens 220 may be less than a focal length of the second lens 240. A width expansion ratio of incident light output from the BLU 110 may be determined based on a ratio between the focal length of the first lens 220 and the focal length of the second lens 240.

In an example, the DMD 210 may diffract incident light 201 in directions indicated by solid lines of FIG. 2. In this example, the first lens 220 may concentrate the incident light onto a center of a Fraunhofer envelope on the liquid crystal optical shutter 230. The incident light may sequentially pass through the liquid crystal optical shutter 230 and the second lens 240, and may be incident on the SLM 120 as shown in FIG. 2.

In another example, the DMD 210 may diffract the incident light 201 in directions indicated by dashed lines of FIG. 2. In this example, the first lens 220 may concentrate the incident light onto the liquid crystal optical shutter 230. The incident light may sequentially pass through the liquid crystal optical shutter 230 and the second lens 240, and may be incident on the SLM 120 as shown in FIG. 2.

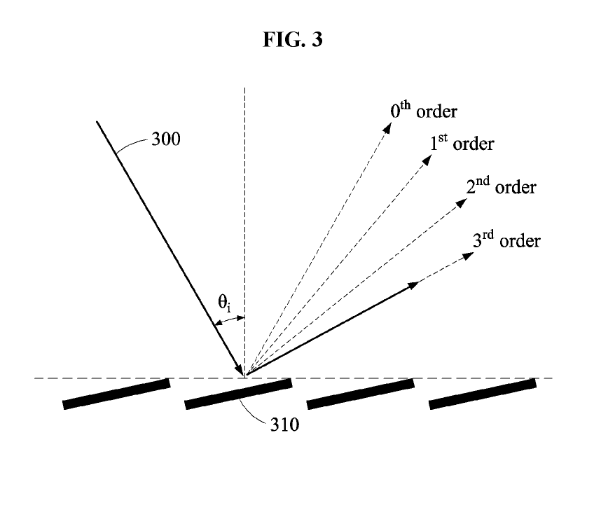

FIG. 3 is a diagram illustrating an example in which light 300 incident on a DMD is in a blaze condition according to an example embodiment.

When the light 300 incident on a mirror 310 included in the DMD satisfies the blaze condition, an envelope peak may be formed in a 3^{rd} order as shown in FIG. 3.

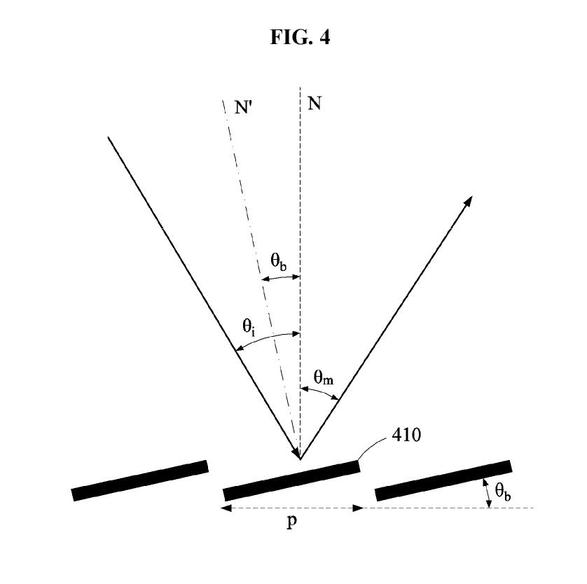

FIG. 4 is a diagram illustrating an example of a process of inducing a blaze condition in a DMD according to an example embodiment.

When a gap between pixels, an order mode, and an input wavelength are denoted by p, m, and λ, respectively, the blaze condition of the DMD may be represented as shown in Equation 1 below.

θₘ=θᵢ−2θ_{b}

mλ=p(sin θᵢ+sin θₘ)

with sign convention: θₘ→−θₘ, θ_{b}=(θᵢ+θₘ)/2

mλ=p[sin θᵢ+sin(2θ_{b}−θᵢ)] [Equation 1]

In Equation 1, θᵢ denotes an angle of incidence based on a perpendicular line N when the DMD is placed on a plane, and θ_{b} denotes a slope in an on state of a pixel in the DMD. Also, θₘ denotes an angle between diffracted light and the perpendicular line N in an on state of a pixel in the DMD.

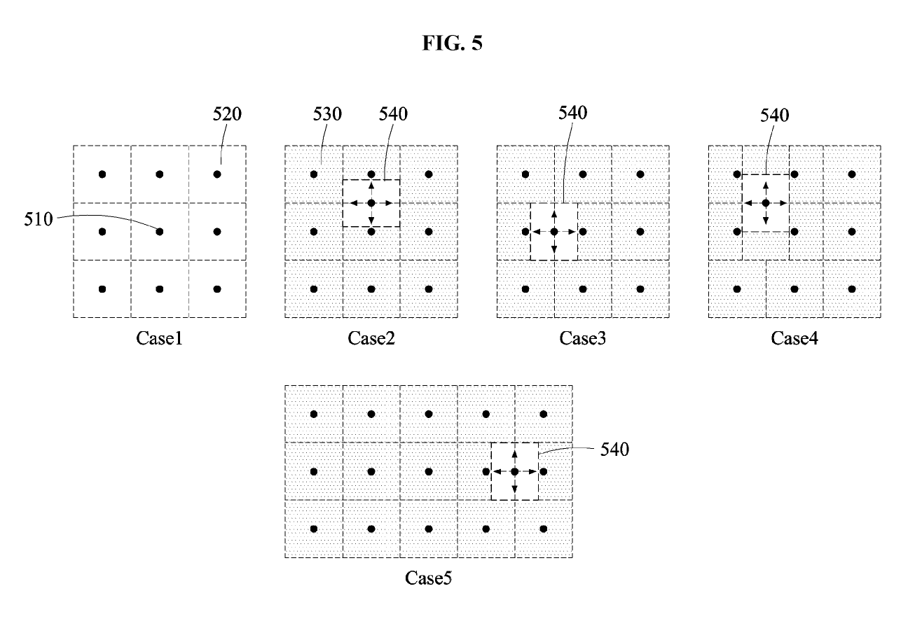

FIG. 5 is a diagram illustrating an example of an operation of a liquid crystal optical shutter according to an example embodiment.

When a BLU does not operate, the liquid crystal optical shutter 230 of FIG. 2 may open regions corresponding to all pixels 520 and orders generated by the grating structure of the DMD 210 of FIG. 2, as shown in case 1 of FIG. 5.

When phase shift encoding of a pattern reproduced on the DMD 210 is performed in a Y-axis direction, the liquid crystal optical shutter 230 may open a region 540 adjacent to an order 510 in the Y-axis direction and may close the other regions 530, as shown in case 2 of FIG. 5.

When phase shift encoding of a pattern reproduced on the DMD 210 is performed in an X-axis direction, the liquid crystal optical shutter 230 may open a region 540 adjacent to the order 510 in the X-axis direction and may close the other regions 530, as shown in case 3 of FIG. 5.

When phase shift encoding of a pattern reproduced on the DMD 210 is performed in the X-axis direction and the Y-axis direction, the liquid crystal optical shutter 230 may open a region 540 diagonally adjacent to the order 510 and may close the other regions 530, as shown in case 4 of FIG. 5.

When a pattern reproduced on the DMD 210 is out of a range of orders, the liquid crystal optical shutter 230 may open a region 540 that is not adjacent to the order 510, as shown in case 5 of FIG. 5.

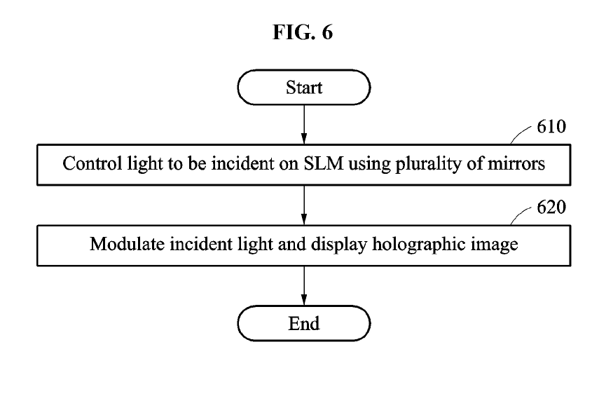

FIG. 6 is a flowchart illustrating a holographic display method according to an example embodiment. The holographic display method may be performed by the holographic display apparatus 100 of FIG. 1.

Referring to FIG. 6, in operation 610, the BLU 110 may control light to be incident on the SLM 120 using the plurality of mirrors. The incident light may have a planar wavefront and a spatially uniform intensity and may be incident at a blaze angle on a DMD.

For example, the BLU 110 may include the DMD, a first lens, a liquid crystal optical shutter, and a second lens. The DMD may include a plurality of mirrors configured to diffract the incident light in a range between orders based on a grating equation. The first lens may concentrate the diffracted light onto a preset position of a focal point. The liquid crystal optical shutter may open a specific region corresponding to the diffracted light based on positions of the orders and a direction of the diffracted light. The second lens may allow light passing through the liquid crystal optical shutter to be incident on the SLM 120.

The DMD may change a diffraction direction in which the incident light is diffracted, by controlling a tilt of each of the mirrors included in the DMD, and may control switching of pixels of the BLU 110. When the direction of the diffracted light corresponds to a position of an order, the liquid crystal optical shutter may open a region that is based on a movement pattern of the diffracted light so that the order may pass through the liquid crystal optical shutter.

In operation 620, the SLM 120 may modulate the incident light based on image information and may display a holographic image.

According to example embodiments, a DMD including a plurality of mirrors may be used as a light steering device of a BLU in a holographic display apparatus, and thus it is possible to prevent an occurrence of noise and vibrations for steering of incident light and to reduce a power consumption for the light steering device.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The method according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A holographic display apparatus comprising:
a backlight unit (BLU) configured to control light to be incident on a spatial light modulator (SLM) using a plurality of mirrors; and
the SLM configured to modulate the incident light based on image information and to display a holographic image.

2. The holographic display apparatus of claim 1, wherein the BLU comprises:
a digital micromirror device (DMD) comprising a plurality of mirrors configured to diffract the incident light in a range between orders based on a grating equation;
a first lens configured to concentrate the diffracted light onto a preset position of a focal point;
a liquid crystal optical shutter configured to open a region corresponding to the diffracted light based on positions of the orders and a direction of the diffracted light; and
a second lens configured to allow light passing through the liquid crystal optical shutter to be incident on the SLM.

3. The holographic display apparatus of claim 2, wherein the DMD is configured to change a diffraction direction in which the incident light is diffracted, by controlling a tilt of each of the mirrors, and to control switching of pixels of the BLU.

4. The holographic display apparatus of claim 2, wherein the DMD is configured to set a maximum angle of diffraction of each of the mirrors based on a gap between the mirrors, an input wavelength of the incident light and an order mode.

5. The holographic display apparatus of claim 2, wherein the liquid crystal optical shutter is further configured to open a region that is based on a movement pattern of the diffracted light so that an order passes through the liquid crystal optical shutter when the direction of the diffracted light corresponds to a position of the order.

6. The holographic display apparatus of claim 2, wherein the liquid crystal optical shutter is further configured to open a region adjacent to an order in an X-axis direction when phase shift encoding of the incident light is performed to move the diffracted light in the X-axis direction.

7. The holographic display apparatus of claim 2, wherein the liquid crystal optical shutter is further configured to open a region adjacent to an order in a Y-axis direction when phase shift encoding of the incident light is performed to move the diffracted light in the Y-axis direction.

8. The holographic display apparatus of claim 2, wherein the liquid crystal optical shutter is further configured to open a region diagonally adjacent to an order when phase shift encoding of the incident light is performed to move the diffracted light in an X-axis direction and a Y-axis direction.

9. The holographic display apparatus of claim 2, wherein the liquid crystal optical shutter is further configured to open a region that is not adjacent to an order when the direction of the diffracted light is out of the range.

10. The holographic display apparatus of claim 2, wherein the liquid crystal optical shutter is further configured to control an intensity of the light that is diffracted by the DMD and that passes through the liquid crystal optical shutter using a liquid crystal included in the liquid crystal optical shutter.

11. The holographic display apparatus of claim 2, wherein a focal length of the first lens is less than a focal length of the second lens, and a beam width of light incident on the SLM is determined based on the focal length of the first lens and the focal length of the second lens.

12. The holographic display apparatus of claim 1, wherein the incident light has a planar wavefront and a spatially uniform intensity, and is incident at a blaze angle on the DMD.

13. A holographic display method comprising:
controlling, by a backlight unit (BLU), light to be incident on a spatial light modulator (SLM) using a plurality of mirrors; and
modulating, by the SLM, the incident light based on image information and displaying a holographic image.

14. The holographic display method of claim 13, wherein the BLU comprises:
a digital micromirror device (DMD) comprising a plurality of mirrors configured to diffract the incident light in a range between orders based on a grating equation;
a first lens configured to concentrate the diffracted light onto a preset position of a focal point;
a liquid crystal optical shutter configured to open a region corresponding to the diffracted light based on positions of the orders and a direction of the diffracted light; and
a second lens configured to allow light passing through the liquid crystal optical shutter to be incident on the SLM.

15. The holographic display method of claim 14, wherein the controlling comprises opening, by the liquid crystal optical shutter, a region adjacent to an order in an X-axis direction when phase shift encoding of the incident light is performed to move the diffracted light in the X-axis direction.

16. The holographic display method of claim 14, wherein the controlling comprises opening, by the liquid crystal optical shutter, a region adjacent to an order in a Y-axis direction when phase shift encoding of the incident light is performed to move the diffracted light in the Y-axis direction.

17. The holographic display method of claim 14, wherein the controlling comprises opening, by the liquid crystal optical shutter, a region diagonally adjacent to an order when phase shift encoding of the incident light is performed to move the diffracted light in an X-axis direction and a Y-axis direction.

18. The holographic display method of claim 14, wherein the controlling comprises opening, by the liquid crystal optical shutter, a region that is not adjacent to an order when the direction of the diffracted light is out of the range.

19. The holographic display method of claim 13, wherein the controlling comprises controlling, by a liquid crystal optical shutter of the BLU, an intensity of the light that is diffracted by the DMD and that passes through the liquid crystal optical shutter using a liquid crystal included in the liquid crystal optical shutter.
